(19) United States
(12) Patent Application Publication
(10) Pub. No.: US 2012/0048679 A1
(43) Pub. Date: Mar. 1, 2012

(54) Device for Separating Plate-Shaped Elements

(75) Inventors: Boris Matzner, Langweid (DE); Bernhard Brain, Langweid (DE)

(73) Assignee: AMB APPARATE + MASCHINENBAU GMBH, Langweid (DE)

(21) Appl. No.: 13/202,129

(22) PCT Filed: Feb. 19, 2010
(86) PCT No.: PCT/EP10/01068

§ 371 Date: Nov. 7, 2011

(30) Foreign Application Priority Data
Feb. 20, 2009 (DE) 10 2009 009 917.4

(51) Int. Cl. B65G 17/46; B65G 15/24

(52) U.S. Cl. 198/586; 198/606

(57) ABSTRACT

The invention relates to a device for separating disc shaped elements from a stack (2). The device has a first belt conveyor device (6) and a second belt conveyor device (7). The first belt conveyor device (6) is provided for receiving in each case one disc-shaped element from a stack (2). The second belt conveyor device (7) is provided for further transport and for the depositing of the disc-shaped elements on a transport device (8) which leads further. The first and the second belt conveyor devices (6, 7) are connected to a device (VP) which generates a vacuum. A first belt of the first belt conveyor device (6) has first openings and a second belt of the second belt conveyor device (7) has second openings. Here the opening cross sections of the second openings are smaller than the opening cross sections of the first openings.

### FIELD OF THE INVENTION

The invention relates to a device for separating plate-shaped elements from a stack.

### BACKGROUND OF THE INVENTION

The use of belt-conveyor means for separating stacked, plate-shaped elements is known, for example, from DE 10 2006 011 870 A1. The stack is moved towards the belt in the direction of its stacking axis. The belt itself is guided along a vacuum-pressure device and provides several openings, through which the surrounding medium is drawn into the vacuum-pressure device. In the event of a contact between a surface of the elements of the stack to be separated and the belt, a vacuum pressure is formed, which holds the element to be separated on the belt. The direction of movement of the belt and the orientation of the stacking axis are disposed perpendicular to one another. As a result, the element to be separated is withdrawn from the stack laterally with reference to the stacking axis and supplied to the further transport mechanism.

In order to remove the next plate-shaped element, the stack is then again guided towards the belt in the direction of the stacking axis. In the case of the separating device known from DE 10 2006 011 870 A1, further belt conveyors are arranged following the first belt conveyor. While the first belt conveyor fitted with the vacuum-pressure device is provided for removing in each case the first plate-shaped element from the stack in a vertical direction against gravity, a belt conveyor, of which the conveying direction is inclined through approximately 45° relative to the conveying direction of the first belt conveyor is arranged following this. A further belt conveyor is arranged opposite to the belt of the first belt conveyor, so that an element removed laterally from the stack is clamped between the belt of the first belt conveyor and the further belt conveyor and transported in this manner. After leaving the belt of the first belt conveyor, the element to be transported falls onto the part of the following belt conveyor arranged diagonally to the former for this purpose. If the force of gravity is insufficient, a stripping device is arranged on the further belt conveyor in order to achieve a secure release of any potentially adhering plate-shaped elements.

The known conveyor device provides several disadvantages. For example, until the transfer to the devices used for the further transport, only the first belt conveyor is provided, which draws the surrounding fluid through a belt hand provided with perforations in order to release the first element of the stack. By contrast, the further belts of the following transport and conveyor devices are not perforated and also do not provide vacuum-pressure devices. In this case, transport is possible only on the basis of the forces arising through adhesion and respectively on the basis of gravity. In the manufacture of semiconductor products, it is often necessary to separate a stack of wafers, which originates, for example, from a cutting process. At this time, the stack is disposed in a bath of liquid. In order to allow a secure lifting of individual wafers in this context, a vacuum pressure is used in the first belt conveyor. The stack is supplied in a horizontal orientation, so that the conveying direction extends perpendicular to the stacking axis, and accordingly, the first element in each case is withdrawn from the bath of liquid in a vertical direction. Over the entire transport distance, a secure adhesion of the removed plate-shaped element on the belt is necessary. For this purpose, in the case of IDE 10 2006 011 870 A1, a belt perforated according to a given pattern is used. However, after the lifting, holding is provided only by adhesion or a clamping of the plate-shaped elements between two belts. Accordingly, the holding forces are very uncertain, and problems frequently occur in the production process, because a secure transfer to the further transport devices is not guaranteed.

### SUMMARY OF THE INVENTION

The invention is therefore based on the object of providing a separating device, in which the plate-shaped elements can be guided individually from a stack to a further transport device.

The object is achieved by the devices according to the invention with the features specified in claim 1.

The separating device according to the invention for separating plate-shaped elements from a stack as specified in claim 1 provides a first belt-conveyor device and a second belt-conveyor device. In this context, the first belt-conveyor device is used for receiving in each case one plate-shaped element from a stack, and the second belt-conveyor device is used for further transport and for depositing the plate-shaped elements on a further transport device. According to the invention, the first and the second belt-conveyor devices are connected to a device generating a vacuum pressure, such as a vacuum pump. While a first belt of the first belt-conveyor device provides openings of a first cross-section, second openings are introduced into the second belt of the second belt-conveyor device. The openings of the first belt-conveyor device provided in this context are relatively larger in cross-section than the second openings of the second belt-conveyor device. The provision of vacuum-pressure devices for the first belt-conveyor device and also for the second belt-conveyor device ensures that the plate-shaped elements adhere securely on the respective belt. At the same time, a drying, which can occur when the plate-shaped elements, are removed from the liquid bath, is prevented through the different cross-sections of the openings of the first belt and of the second belt. Further handling is considerably simplified through the secure adhesion based on the generated vacuum pressure. In particular, a premature falling of the plate-shaped elements before finally being deposited on a further transport device is avoided. A targeted deposition can be achieved, because the plate-shaped elements, which also adhere securely to the second belt-conveyor device because of the vacuum pressure, can be moved together with the second belt-conveyor device. Accordingly, an active deposition on the further transport device is possible.

Advantageous further developments of the device according to the invention are specified in the dependent claims.

In particular, it is advantageous if the openings of the first belt are introduced into the belt as recesses, whereas cuts are introduced in the second belt to form the openings. The large openings are advantageous for the release of the plate-shaped element from the stack. As a result of the vacuum-pressure device, relatively large volume flows can pass here. Accordingly, the suctioning of the plate-shaped element from the stack is achieved with a comparatively large force. However, after the element lifted has been removed from the liquid bath, there is a danger of a drying of the surface of the plate-shaped element in regions in which the plate-shaped element is not in contact with the belt because an opening is present there. This is undesirable, because it can lead to an increase in rejects. Accordingly, only cuts are introduced as openings in the second belt band. In fact, the generation of a vacuum pressure to increase the holding force on the belt through the cuts is still possible. At the same time, however, a drying of an exposed surface of the plate-shaped element is prevented. The introduction of cuts into the further belt bands ensures chat the surface of the plate-shaped element, which, for the sake of simplicity, is also referred to below in general terms as a wafer, is in contact with the belt thereby preventing a drying of the surface.

Moreover, the second belt-conveyor device preferably provides at least one portion, which is arranged in a rotatable manner. The rotation which is implemented with reference to the conveying plane of the first belt-conveyor device, allows a transfer of the plate-shaped element with a conveying plane identical to the first belt-conveyor device and a deposition of the plate-shaped element in a plane inclined relative to the latter, especially a horizontal plane. In this rotated, second position, the plate-shaped element is released from the belt of the portion of the second belt-conveyor device, which is rotatable and supplied to a further transport device. This can be achieved simply, for example, by depositing onto a strap gear or a further conveyor belt. An uncontrolled tilting in order to deposit the plate shaped element on a further diagonally extending conveyor plane is therefore avoided. The rotatable portion is arranged in such a manner that, initially, in a starting position of the rotatable portion, the conveying plane of the first belt-conveyor device is parallel to the conveying plane of the rotatable portion of the second belt-conveyor device in this context, in each case, the plane in which the contact surface between the belt and the plate-shaped element is disposed, is defined as the conveying plane. The second, rotated position of the portion of the second belt-conveyor device is selected in such a manner that the conveying plane encloses an angle with the conveying plane of the first belt-conveyor device in this position. The intersecting line between these two planes is preferably disposed perpendicular to both conveying directions.

Accordingly, it is particularly advantageous if the second belt-conveyor device provides a first and second portion. The conveying plane of the first portion in this context is preferably identical to the conveying plane of the first belt-conveyor device, so that, over this portion, the plate-shaped element is transported further in the vertical direction. Accordingly, the distance from the liquid, bath is initially increased. This relatively greater may often be required, because the further transport device itself provides a given structural height. However, in order to prevent a drying of the surface of the plate-shaped element from occurring even in this first transport portion, the first belt-conveyor device is kept as short as possible. After a complete release of the first plate-shaped element from the stack has been achieved in each case, a transfer to the second belt-conveyor device or respectively to its first portion is then implemented as soon as possible. In order to preserve the necessary distance from the liquid bath, a further vertical conveying is initially implemented by the first portion of the second belt-conveyor device. By contrast, the second portion of the second belt-conveyor device is designed to be rotatable. In this context, a transfer to the further transport device, which preferably conveys the plate-shaped element exclusively using gravity, can be implemented.

In one special embodiment of the invention, the rotatable portion and the first belt-conveyor device are arranged in such a manner that the plate-shaped elements are held on different surfaces by the first portion and the second portion. While the first portion is in contact with a first surface of the wafer, after the transfer to the second portion, a holding force is generated on the second surface of the wafer facing away from the former. Accordingly, in the transport direction, the first portion and the second portion are arranged offset relative to one another to such an extent chat a clamping force does not act on the wafer at any time. On the contrary, a conveying on the belt of the first portion is implemented until the wafer projects beyond its end. At this projecting end, a holding force is then applied, by the second portion.

At the same time, however, the distance in the transport direction is selected to be so short that a secure adhesion of the wafer on the belt of the first and/or the second portion is guaranteed at all times. In particular, the wafer is in contact with the region in which a vacuum pressure is generated through the belt.

In a preferred, alternative embodiment of the invention, the rotatable portion and the first belt-conveyor device are arranged, by contrast, in such a manner that the plate-shaped elements conveyed by the first belt-conveyor device contact its belt, with the first surface, and the plate-shaped elements conveyed by the rotatable portion of the second belt-conveyor device also contact the belt of the rotatable portion with the same first surface. Accordingly, in a rotated position, the second portion can assume the function of a further transport device.

Furthermore, it is preferable if a transport plane of the further transport device is disposed parallel to the conveying direction of the rotatable portion in its rotated position. This is particularly advantageous if the transport plane is orientated horizontally, so that, in the rotated position, the wafer can readily be deposited on the further transport device. In particular, the rotatable portion of the second belt-conveyor device and the further transport device are also aligned relative to one another in such a manner that the belt of the rotatable portion and a conveying means of the further transport device are disposed opposite to one another in the rotated position of the second belt-conveyor device. Accordingly, in the rotated position, while the wafer is still initially held by the vacuum pressure on the belt of the second portion of the second belt-conveyor device, the conveying means of the further transport device is already arranged on the side of the wafer facing away from the latter. If the wafer is now released from the belt, it can be deposited directly onto the conveying means of the further transport device.

This is particularly advantageous, because a wetting device can be arranged in this region. Since the transport of the plate-shaped elements is implemented by holding onto different surfaces, the respectively free surface of the plate-shaped element can be wetted. For this purpose, a wetting device is preferably provided in the region of the further transport device and the rotatable portion.

The second belt-conveyor device preferably provides a displaceable device for deflecting the belt on a side facing away from the transport side, that is to say, the surface of the belt corning into contact with the wafer. While she belts run in a conventional manner over two rollers and extend in a straight line along a guide surface disposed between the former, a deflection of the belt can be achieved by means of the displaceable device. This deformation of the belt means that a plate-shaped element adhering to the belt is released, so long as a given bending rigidity of the element is present. Even in the case of elements with a bending elasticity, the release is supported by an impulse of this kind, which is ideally brief.

By preference, the displaceable device provides an elastic element or is formed in its entirety by the elastic element. This elastic element can be filled with a fluid in order to enlarge its volume. The elastic element is accommodated in a retaining chamber of the second belt-conveyor device. In the case of an enlargement of the volume by filling, for example, with a fluid, the volume of the elastic element, exceeds the volume of the retaining chamber. Accordingly, it partially emerges from the retaining chamber and leads to a deformation of the belt, which extends directly along the open side of the retaining chamber when the elastic element is not filled. The enlargement of the elastic element can also be transferred to the belt indirectly.

Further details and advantages of the separating device according to the invention are explained in greater detail below with reference to the drawings:

### BRIEF DESCRIPTION OF THE DRAWING

FIG. 1 shows a schematic view elucidating the overall procedure of the separating process;

FIG. 2 shows an enlarged view of a separator used for the separation;

FIG. 3 shows a further enlarged view of the separator from FIG. 2 with a rotated second portion of the second belt-conveyor device;

FIG. 4 shows a schematic view of a detail of the separator from FIGS. 2 and 3 elucidating the function of the displaceable device; and

FIG. 5 shows a view of the separator from a second perspective;

FIG. 6 shows an enlarged view of an alternative separator used for the separation;

FIG. 7 shows a further enlarged view of the alternative separator used for the separation;

FIG. 8A shows a separating-nozzle device 200;

FIG. 8B shows a parting-nozzle device 60;

### DETAILED DESCRIPTION

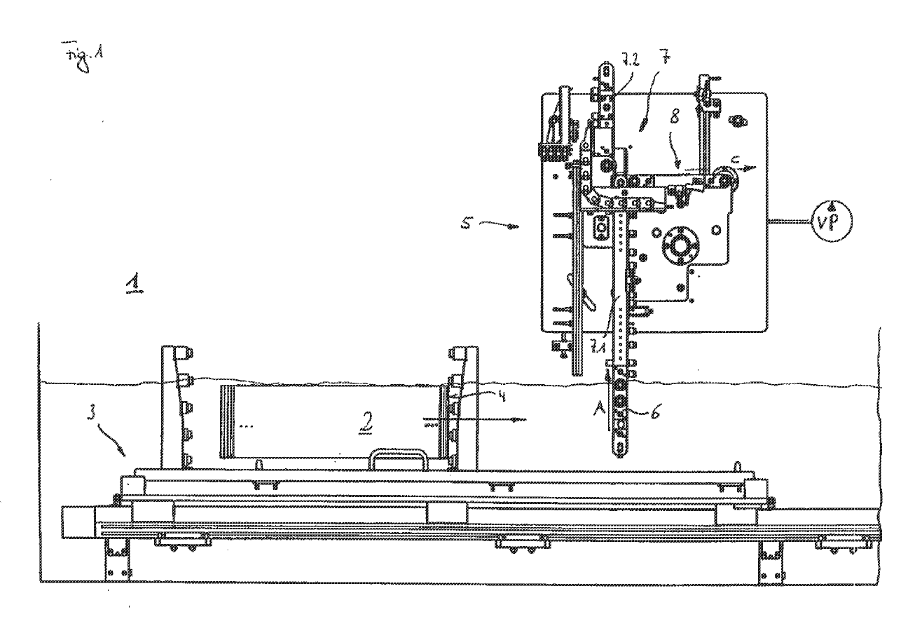

FIG. 1 shows a part of a relatively large plant, which is used in the processing of, for example, wafers. The term “wafer” here denotes substantially plate-shaped elements. In this context, plate-shaped means chat the extension in the first and second dimension is considerably larger than in a third dimension.

The device 1 separates plate-shaped elements from a stack 2. As indicated in FIG. 1 on the right and left side of the stack 2, the stack 2 comprises a plurality of individual plate-shaped elements orientated parallel to one another. These plate-shaped elements are orientated in such a manner that the stacking axis, which extends in the conveying direction indicated by an arrow, is disposed perpendicular to the individual plate-shaped elements. The stack 2 as arranged in a horizontal position in a bath of liquid. In this context, the term “horizontal” relates to the position adopted during operation. As indicated by the waterline, the stack 2 is disposed in its entirety in a bath of liquid, which can be, for example, de-energised or reduced-energy water.

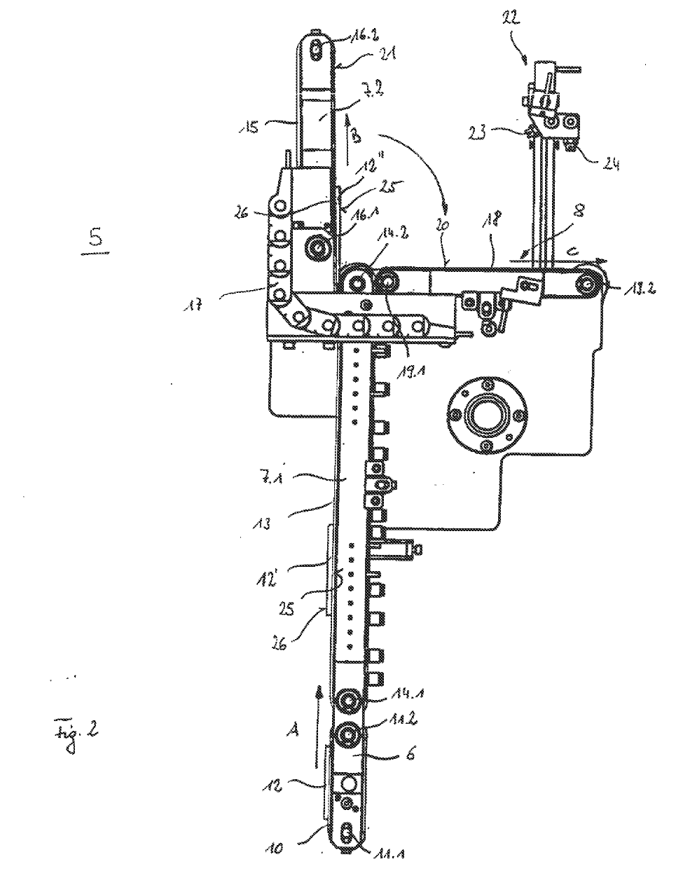

A supply device 3 is arranged in the liquid bath. The stack 2 is arranged on this supply device 3 in a manner not described in greater detail. By means of the supply device 3, the stack 2 is guided in the direction of the stacking axis towards the actual separator 5. To allow an improved visual presentation, only the substantial elements of the separator 5 are illustrated in FIG. 1. A more detailed description is provided below with reference to the further FIGS. 2-5.

The separator 5 provides a first belt-conveyor device 6 and a second belt-conveyor device 7. The second belt-conveyor device 7 provides a first portion 7.1 and a second portion 7.2. The first belt-conveyor device 6, the first portion 7.1 and the second portion 7.2 each provide their own belt, which is, however, preferably driven jointly with the other belts. Accordingly, a velocity matching is required only once in design terms, wherein idling difficulties between the individual conveying portions of the separator 5 cannot occur during operation. By means of the separator 5, a plate-shaped element conveyed from the stack 2 in a manner still to be described is transported towards a further transport device 8. The further transport device 8 transports the separated plate-shaped elements as indicated by the arrow C and can supply them, for example, to a damage-detection and sorting station and/or for further processing.

For the removal of the plate-shaped elements from the stack 2, the stack 2 is transported with the first surface 4 of the first plate-shaped element in the direction of the arrow so far towards the right until the first surface 4 is in contact with the belt of the first belt-conveyor device 6. The first belt-conveyor device 6 and the portions 7.1 and 7.2 of the second belt-conveyor device 7 are each connected to a vacuum pump VP. A vacuum pressure is generated by means of the vacuum pump VP. This vacuum pressure is generated at a side facing away from the contact surface between the plate-shaped elements and the belt within the first belt-conveyor device 6 or respectively the portion 7.1 and the portion 7.2.

For this purpose, the belt of the first belt-conveyor device 6 is guided on its side facing towards the stack 2 along a guide surface. Recesses, which are connected via a line system, which is not illustrated, to the vacuum pump VP, are formed in the guide surface. A pattern of perforations is formed in the belt itself. The pattern of perforations is realised through recesses, which are introduced into the belt. For example, a plurality of circular perforations can be punched into the belt with a uniformly designed pattern. The surrounding fluid of the liquid bath is drawn up by the vacuum pump VP. If the stack 2 is guided in the direction towards the first belt-conveyor device 6 so far that the first surface 4 is in contact with the belt, the openings are closed and, the first plate-shaped element now adheres to the belt of the first belt-conveyor device 6. Accordingly, the circulating belt draws the plate-shaped element in the direction of the arrow A away from the stack 2 and transports it in the direction towards the first portion 7.1 of the second belt-conveyor device 7. Since the second belt-conveyor device 7 and accordingly also the first portion 7.1 is also connected to the vacuum pump VP, the plate-shaped element is also suctioned against the belt here. In the transport direction, which is indicated by the arrow A, the belt of the first belt-conveyor device 6 and the belt of the portion 7.1 of the second belt-conveyor device 7 are arranged offset relative to one another, however, with a common conveying plane. This means that the suctioning of the plate-shaped element is implemented on the same side of the plate-shaped element, namely, on the side of the first surface 4. The spacing distance in the transport direction A is selected in this context in such a manner that, in the region of the transition between the first belt-conveyor device 6 and the second belt-conveyor device 7, for a given time, a suctioning occurs through the first belt-conveyor device 6 and also through the second belt-conveyor device 7. In this context, the length of the first belt-conveyor device 6 is dimensioned approximately in such a manner that the transport length, over which the first plate-shaped element is in contact with the belt, is disposed approximately completely in the bath of liquid.

While recesses are generated in the belt of the first belt-conveyor device 6 by punching, and accordingly, relatively large opening cross sections are generated, the belt of the portion 7.1 of the second belt-conveyor device is provided only with cuts. Accordingly, there is no punching out of material. The belt of the first portion 7.1 and in the same manner of the second portion 7.2 is therefore in fact no longer impermeable to air, and, because of the vacuum pressure generated by the vacuum pump VP, a secure adhesion of the plate-shaped element is achieved. Conversely, at the same time, it is ensured that the entire surface of the plate-shaped elements is in contact with the belt in the region of the active vacuum pressure. Accordingly, an exposed surface in the direction of the vacuum-pressure device, as provided in the region of the recesses of the belt of the first belt-conveyor device 6, is not present. This prevents a partial drying of the surface in the region of the recesses.

The belt of the first portion 7.1 of the second belt-conveyor device 7 transports the plate-shaped element further in a vertical direction and with a conveying plane identical to the conveying plane of the first belt-conveyor device 6. The transport by the first portion 7.1 can continue so long as a secure adhesion on the belt of the first portion 7.1 is guaranteed. In the region in which a contact of the plate-shaped element must be provided, the belt also passes over a guide surface, in which openings are provided, which are connected via a further channel system to the vacuum, VP. At some time, the front edge of the plate-shaped element in the transport direction reaches the end of the belt of the first portion 7.1. Since the belts run over rollers and the remaining part of the plate-shaped element are still held on the belt by the vacuum pressure and additional adhesive forces, an end of the plate-shaped element projecting upwards in the vertical direction in FIG. 1 now arises. This end now comes into contact at the side facing away from the belt of the first portion 7.1 with the belt of the second portion 7.2. Here also, cuts are introduced, into the belt, as already described above. As a result of the vacuum pressure generated there, a secure adhesion on the belt of the second portion 7.2 is now achieved. Since the belts are driven by the same drive, they run at the same conveying velocities. A seamless transfer to the belt of the second portion 7.2 is therefore guaranteed. Here also, the distance in the transport direction A is selected in such a manner that, at the time of the transfer, a vacuum pressure acts on the plate-shaped element through the first portion 7.1 and also through the second portion 7.2, although on different surfaces.

After the plate-shaped element has been completely transferred to the second portion 7.2 of the second belt-conveyor device 7 through further transport in direction A, the second portion 7.2 is rotated through 90°, in a clockwise direction in FIG. 1. The conveying plane of the second portion 7.1 now extends parallel to the transport plane of the further transport device 8. In this context, the rotary bearing, about which the second portion 7.2 can be rotated as a rotatable portion of the second belt-conveyor device, is positioned in such a manner that the spacing distance formed between the belt of the second portion 7.2 and the transport device is a somewhat wider than the thickness of the plate-shaped element. This ensures that a clamping of the plate-shaped elements, which leads to mechanical stress, is avoided. Moreover, as will be explained in greater detail below, the release from the belt of the second portion 7.2 can be favoured through a deformation of the belt 7.2. A given movement play is required for this purpose.

FIG. 2 shows, once again, an enlarged view of the separator 5. It is again evident that the first belt-conveyor device 6 initially receives a plate-shaped element 12 illustrated by way of example. The plate-shaped element 12 is disposed with one surface in contact with the belt 10 of the first belt-conveyor device 6. At the side facing away from this plate-shaped element, the belt 10 extends in contact with a guide surface. As already described, the recesses, which are connected via a line system to the vacuum pump VP, are arranged in the guide surface. The belt 10 is designed in a similar manner to an endless conveyor belt and mounted between two rollers. The rollers are mounted in a rotatable manner in a first rotary bearing 11.1 and a second rotary bearing 11.2, wherein one of the toilers is connected to a drive system which is not illustrated in FIG. 2.

In a similar manner, the second belt-conveyor device 7 provides a first portion 7.1. Here also, a belt formed in an endless manner, which is mounted over two rollers, is provided. The rotary bearings 14.1 and 14.2 are disposed in a line with the two rotary bearings 11.1 and 11.2. The roller diameters are selected to be identical in size, so that the first belt 10 and the second belt 13 provide a common conveying plane. Reference number 12 in FIG. 2 indicates a plate-shaped element, which, at a later time, is in contact only with the belt 13 of the first portion 7.1. The plate-shaped element 12′ contacts the belt 13 with its first surface 25. The second surface 26 facing away from the latter is exposed and can be protected from drying, for example, by a wetting device which is not illustrated in FIG. 2. The need to provide such a wetting device is dependent upon the respective application. The belts 10 and 13 are driven synchronously, so that a further conveying in she direction of the arrow A is implemented by the second belt-conveyor device 7 or, initially its first portion 7.1. At an even later time, the plate-shaped element is disposed in the position marked with 12″. The second portion 7.2 also provides a first rotary bearing 16.1 and a second rotary bearing 16.2. The two rotary bearings 16.1 and 16.2 once again bear rollers, with which a belt 15 of the second portion 7.2 is tensioned and driven. At the same time, the second portion 7.2 as a whole is arranged in a rotatable mariner about the first rotary bearing 16.1. Accordingly, the conveying plane can be rotated preferably through approximately 90°.

It should be noted that the rotation through 90° is not supposed to represent a restriction of the present invention. It comes about because the further transport device 8, which will be explained in greater detail below, is rotated through 90° relative to the conveying plane of the first belt-conveyor device 6 and of the first portion 7. Initially, the second portion 7.2 is arranged as shown in FIG. 2, in such a manner that the conveying plane of the second portion 7.2 is formed parallel to the conveying plane of the first belt-conveyor device 6 or respectively of the first portion 7.2. In each case, the conveying plane is the plane, which is defined by the belt surface disposed in contact with the plate-shaped element 12.

The conveying planes of the second portion 7.2 and of the first portion 7.1 accordingly provide a spacing distance which allows the plate-shaped element 12 to be transferred without being deformed. While, towards the end of the transport path of the first portion 7.1, a projecting part at the front edge in the transport direction of the plate-shaped element 12 is already held on the belt 15 of the second portion 7.2 by the vacuum pressure, the part of the plate-shaped element facing more in the direction of the rear edge, viewed in the transport direction, is also held by the first portion 7.1.

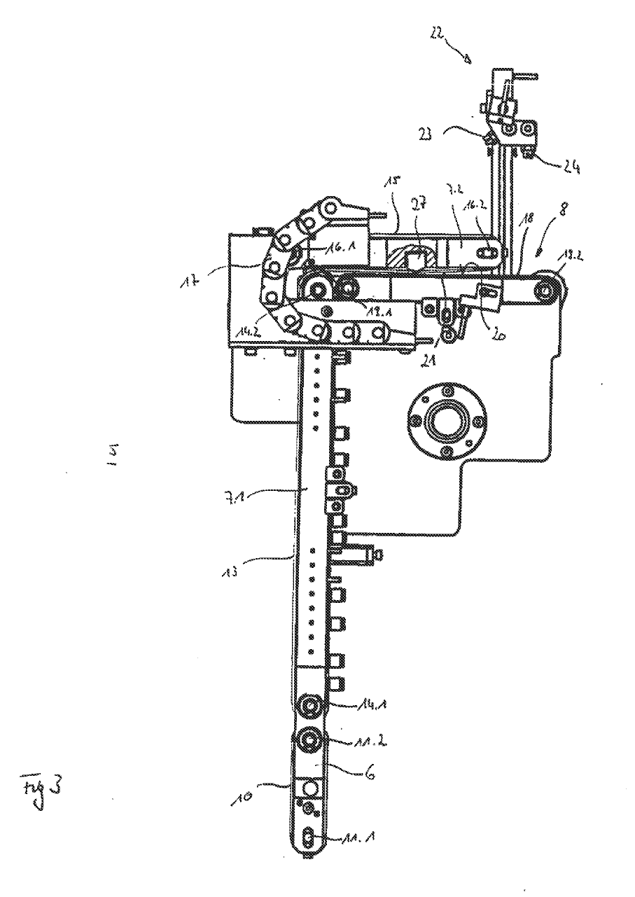

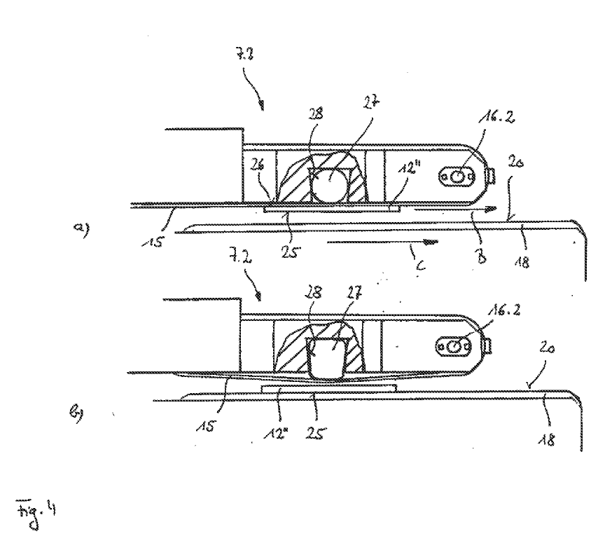

After the plate-shaped element 12″ has been completely transported into the region between the first rotary bearing 16.1 and the second rotary bearing 16.2 of the second portion 7.2, the entire portion 7.2 is rotated about the first rotary bearing 16.1, as illustrated by the arrow in FIG. 2. Since the second surface 26 of the plate-shaped element 12 is in contact with the belt 15 of the second portion 7.2, after this rotation, the first surface 25 is orientated parallel to a transport surface 20 of the conveying means 18 of the further transport device 8, as shown in FIG. 3. The plate-shaped element 12 can now be deposited on the conveying means 18. The conveying means 18 can accordingly be realised either by a further belt-conveyor device or, for example, by a strap gear. In the preferred arrangement shown in FIG. 1, in which the transport direction A is provided in the vertical direction, and the conveying direction towards the further plant c is provided in the horizontal direction, the release from the belt 15 of the second portion 7.2 in the rotated position of the second portion 7.2 can take place by gravity. However, because of the adhesion acting between the belt 15 and the plate-shaped element 12, gravity may, under some circumstances, not be sufficient to release the plate-shaped element 12 securely from the belt 15. Accordingly, a movable element which supports the releasing process is provided at the side of the belt 15 facing away from the plate-shaped element 12″. This is explained, below with reference to FIGS. 4a and 4b.

For the control and formation of vacuum-pressure lines which can be connected to the vacuum pump VP, a movable line guide 17, which is per se known and therefore requires no further explanation, is provided. The line guide 17 can also contain the vacuum-pressure lines alongside electrical lines. A different line guide is also conceivable.

In the region approximately limited in the illustrated starting position by the further transport device 8 and the second portion 7.2, a wetting device 22 is also provided. The wetting device comprises several nozzles 23 and 24. Some of the nozzles, in FIG. 2, for example, the nozzle 23, are orientated here in such a manner that the first surface 25 of the plate-shaped element 12″ is wetted. The second nozzle 24, by contrast, is orientated in such a manner that the second surface 26 of the plate-shaped element 12 can be wetted on the further transport path. Since the further transport device 8 does not contain a vacuum device, the drying of the surface disposed on the conveying means 18 over the further transport path is considerably less critical than in the regions where it is necessary to operate with a vacuum pressure. Accordingly, it is particularly advantageous to form the rotatable portion 7.2 in such a manner that the surface 25 initially facing away from the belt of the rotatable portion 7.2 can be wetted. By contrast, after depositing, the surface lass held by means of the vacuum-pressure device is exposed and can also be wetted. Accordingly, both surfaces of the plate-shaped element can be wetted in a simple manner. The conveying means 18 of the further transport device 3 in the illustrated exemplary embodiment is also a belt-conveyor device and runs over rollers which are mounted in a first rotary bearing 19.1 and a second rotary bearing 19.2.

The rotary movement already described is shown again in FIG. 3. It is evident that the rotatable portion 7.2 of the second belt-conveyor device 7 is arranged parallel to the further transport device 8. Furthermore, a region of the drawing provided in partial section shows that a displaceable device is arranged at the side of the belt 15 facing away from the plate-shaped element 12 to be transported. This is shown once again in enlargement in FIGS. 4a and 4b. In FIG. 4a, the second portion 7.2 is already disposed in its rotated position. In this position, the part of the belt 15 guiding the plate-shaped element 12 is already arranged parallel to a transport plane 20 of the conveying means 18. However, in this context, the belt is arranged so far away from the conveying means 18 that the plate-shaped element 12″ is not clamped between the two conveying parts. Alongside the channels, which are not illustrated in the drawings, a retaining chamber 28 is introduced in the guide portion of the belt of the second portion 7.2, which also accommodates the bearings 16.1 and 16.2. The retaining chamber 28 can be formed, for example, in the shape of a groove, which is open towards the conveying side of the belt 15, and extends substantially across the width of the belt 15. In this retaining chamber 28, an elastic element 27 is formed as a displaceable device. The elastic element 27 is hollow and can be filled with a fluid. So long as the elastic element 27 is non filled, the external dimensions are selected in such a manner that is arranged completely within the retaining chamber 28. The belt can pass flat over the open side of the groove contacting the guiding part of the portion 7.2 through she vacuum-pressure device.

If the plate-shaped element 12 is now transported so far that it reaches the region of the retaining chamber 28, a transfer to the further transport device 8 is required. For this purpose, the elastic element 27 is filled. Either a compressible medium or also an incompressible medium can be used for the filling. The use of a compressible medium provides the advantage that the vacuum pump can be used simultaneously faring the elastic element 27. As a result of the filling process, a volume enlargement of the elastic element 27 occurs. Since the size of the elastic element 27 in the un-filled condition is already designed so that the retaining chamber 28 is largely occupied, the volume enlargement causes an emergence of one part of the elastic element 27 at the open side of the retaining chamber 28. Since the open region of the retaining chamber 28 is limited in practice by the belt, a deformation of the belt, occurs, as shown in FIG. 4b. While, initially, with an un-filled elastic element 27, the second surface 26 of the plate-shaped element 12″ is fully in contact with the belt 15, and is also held there by the vacuum pressure, a full-surface contact of the plate-shaped element 12″, which is rigid by comparison with the belt 15, is now no longer possible. As a result, the plate-shaped element 12″ is released from the belt 15 and falls subject to gravity onto the conveying means 18 it should be noted that a completely rigid element 12″ is not required. Moreover, the vacuum pressure breaks down as a result of the lifting of the belt 15. Furthermore, it is not necessary for the plate-shaped element no be released through a bending movement, which is strongly exaggerated in FIG. 4b. On the contrary, a brief impulse, which acts from the rear side of the belt 15 on the plate-shaped element 12 can also bring about a release of the plate-shaped element. In this case, it is advantageous if the elastic element 27 in the un-filled condition is disposed at a slight spacing distance from the belt 15. The precise control and implementation of the movement of the displaceable device can be matched individually to the respective elasticity of the plate-shaped element 12 and the adhesive forces occurring.

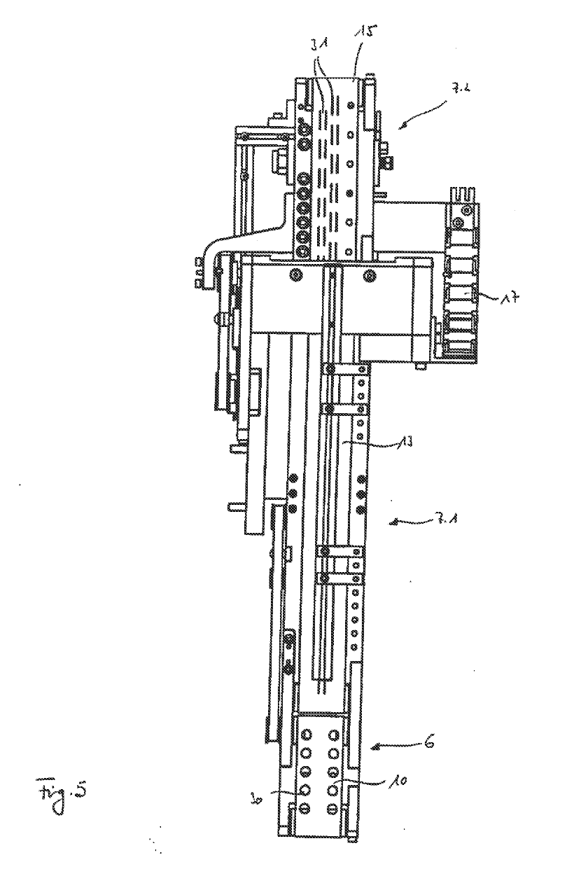

Finally, FIG. 5 again shows a view from the left side of the separator 5 as shown in FIGS. 1-3, wherein the second portion 7.2 is disposed in its starting position. In this view, it can readily be seen that the belt 10 of the first belt-conveyor device 6 provides openings 30, through which the outlets from the channels provided to generate the vacuum pressure can also be seen in the central region. In FIG. 5, the cuts 31 in the belt 15 are indicated only in a schematic manner. For the sake of improved visual clarity, no cuts are shown in the belt 13 in the first portion of the second belt-conveyor device 7. On the left side, it can also be seen that the first belt 10 of the first belt-conveyor device 6 and the second belt 13 of the first portion 7.1 of the second belt-conveyor device 7 are driven by means of a common drive 33. Furthermore, the mechanical part for driving the rotary movement of the rotatable portion 7.2 can be seen on the left side. The mechanical activation provides the advantage of securing a good accuracy of reproduction and process stability with reference to the clock-pulsed rotary movement from the starting position into the rotated position and back again.

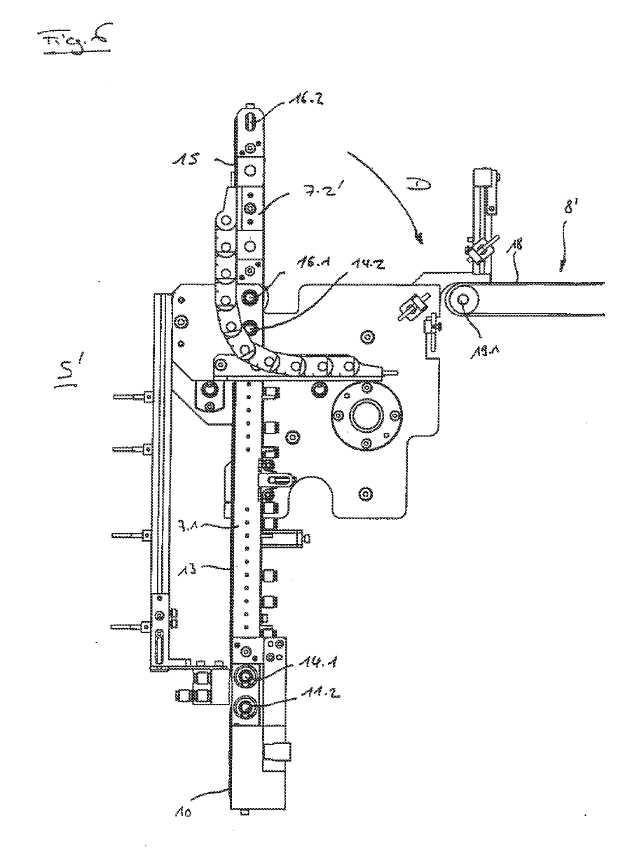

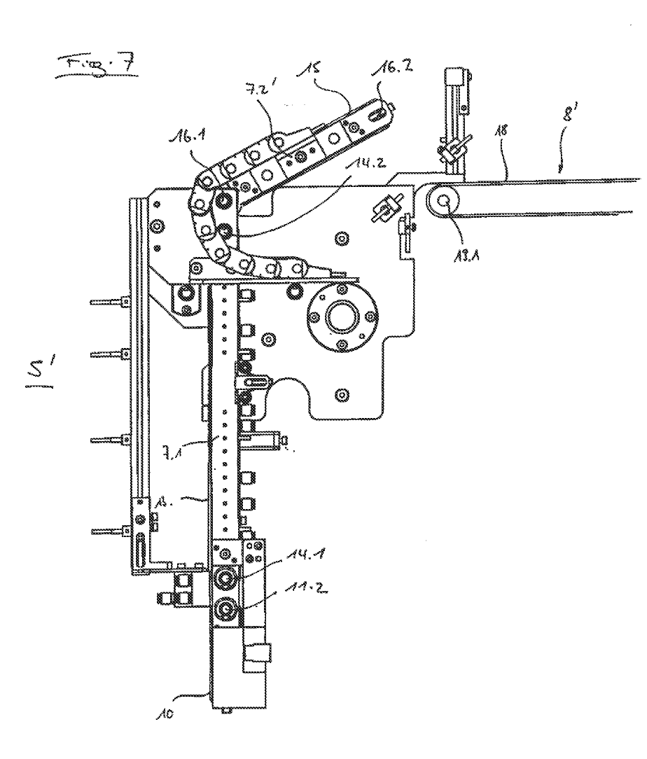

FIGS. 6 and 7 each present an alternative separator 5′, which can be used instead of the separator 5. Apart from some differences explained below, the alternative separator 5 corresponds to the separator 5. However, elements of the separator 5 not illustrated and elements not mentioned here are adopted without change.

By contrast with the separator 5, the alternative separator 5 provides a further transport device 8′, which is provided with a spacing distance from the second belt-conveyor device 7. Instead of the second portion 7.2, the alternative separator 5 provides an alternative second portion 7.2′.

The alternative second portion 7.2 also provides the first rotary bearing 16.1 and the second rotary bearing 16.2. The two rotary bearings 16.1 and 16.2 in the alternative separator 5′ bear rollers, with which the belt 15 of the alternative second portion 7.2′ is tensioned and driven. At the same time, the alternative second portion 7.2′ as a whole is arranged in a rotatable manner about the first rotary bearing 16.1. Accordingly, the conveying plane, which is arranged in the illustrated case perpendicular to the plane of the drawing and vertically in the image, can preferably be rotated through approximately 90° corresponding to the arrow D. The conveying plane of the alternative second portion 7.2′ in the illustrated case is identical to the conveying plane of the first belt-conveyor device 6 and especially also of the portion 7.1′. Starting from the illustrated position, the conveying plane can be rotated through approximately 90° in a clockwise direction and corresponding to the arrow D. With such a rotation of the alternative second portion 7.2′, the conveying plane brought into a position which is identical with the conveying plane of the further transport device 8′. Here also, it should be noted that the rotation through 90° should not represent a restriction of the present invention. For example, smaller or larger angles can also be used.

The first rotary bearing 16.1 of the alternative second portion 7.2′ is displaced relative to the first rotary bearing 16.1 of the second portion 7.2. The first rotary bearing 16.1 of the alternative second portion 7.2 is disposed in one line with the rotary bearings 14.1 and 14.2 of the first portion 7.1 and with the rotary bearings 11.1 and 11.2 of the first belt-conveyor device 6. Moreover, the rotary bearings 16.1, 14.1, 14.2, 11.1 and 11.2 are orientated parallel to one another.

The alternative second portion 7.2′ in FIG. 6 is arranged in such a manner that the conveying plane of the alternative second portion 7.2′ is formed in an identical manner to the conveying plane of the first belt-conveyor device 6 or respectively of the first portion 7.1. The conveying planes of the alternative second portion 7.2′ and of the first portion 7.1 also coincide and are orientated in an identical manner, so that the contact surfaces are disposed on the left hand sides in FIG. 6 of the first portion 7.1 and of the alternative second portion 7.2′.

In the alternative separator 5′, the first belt-conveyor device 6, the first portion 7.1 and the alternative second portion 7.2′ also each provide their own belt. The belts can optionally be driven together, as in the separator 5, or separately, so that each belt provides an individual velocity. By means of the vacuum pump VP, a vacuum pressure is also generated in the alternative second portion 7.2′ at a side of the belt 15 facing away from the contact surface between the plate-shaped elements and the belt 15. The belt of the alternative second portion 7.2′ is also impermeable to air, wherein a secure adhesion of the plate-shaped elements is achieved on the basis of the vacuum pressure generated by the vacuum pump VP. In this case also, it is simultaneously ensured that the surface of the plate-shaped elements is fully in contact with the belt in the region of the active vacuum pressure. The first and also the second belt-conveyor device 6, 7 are both connected to the vacuum pump. The first belt 10 of the first belt-conveyor device 6 still provides the first openings 30, while the second belt 15 of the second belt-conveyor device 7 still provides second openings. The opening cross sections of the second openings in this context are smaller than the opening cross sections of the first openings. The first openings 30 of the first belt are introduced into the belt 10 as recesses. The second openings in the second belt are introduced as cuts 31.

During the transport of a plate-shaped element, the front edge of the plate-shaped element in the transport direction reaches the end of the first portion 7.1. The front edge of the plate-shaped element in the transport direction now comes, at the side disposed in contact with the belt of the first portion 7.1, into contact with the belt of the alternative second portion 7.2′. Through the vacuum pressure generated there, a secure adhesion on the belt of the alternative second portion 7.2′ now takes place. Since the belts are driven by the same drive, as in the case of the separator 5, they run at the same conveying velocities, thereby guaranteeing a seamless transfer to the belt of the alternative second portion 7.2′. At the time of the transfer, a vacuum pressure acts both through the first portion 7.1 and also through the second portion 7.2 on one and the same surface of the plate-shaped element. This means that the rotatable, alternative second portion 7.2′ and the first belt-conveyor device 6 are arranged in such a manner that the plate-shaped elements 12 conveyed by the first belt conveyor device 6 contact its belt 10 with the first surface 25, and the plate-shaped elements 12 conveyed by the rotatable alternative second portion 7.2 of the second belt-conveyor device 7 also contact the belt 15 of the rotatable, alternative second portion 7.2′ with the first surface 25.

After the complete further transport of the plate-shaped element onto the alternative second portion 7.2′ of the second belt-conveyor device 7, the alternative second portion 7.2 is rotated through 90° in a clockwise direction. The alternative second portion 7.2′ now simultaneously assumes the function of the further transport device 3 of the exemplary embodiment of FIG. 2.

The alternative second portion 7.2′ does not require a device for the deflection of the belt 15, because the deposition through the rotation of the second portion exploits the force of gravity and a transfer during the deposition is not required. Accordingly, the alternative second portion 7.2′ in the illustrated exemplary embodiment does not provide a device for the deflection of the belt 15.

The invention is not restricted to the illustrated exemplary embodiments in particular, individual features of the invention can also be advantageously combined with one another.

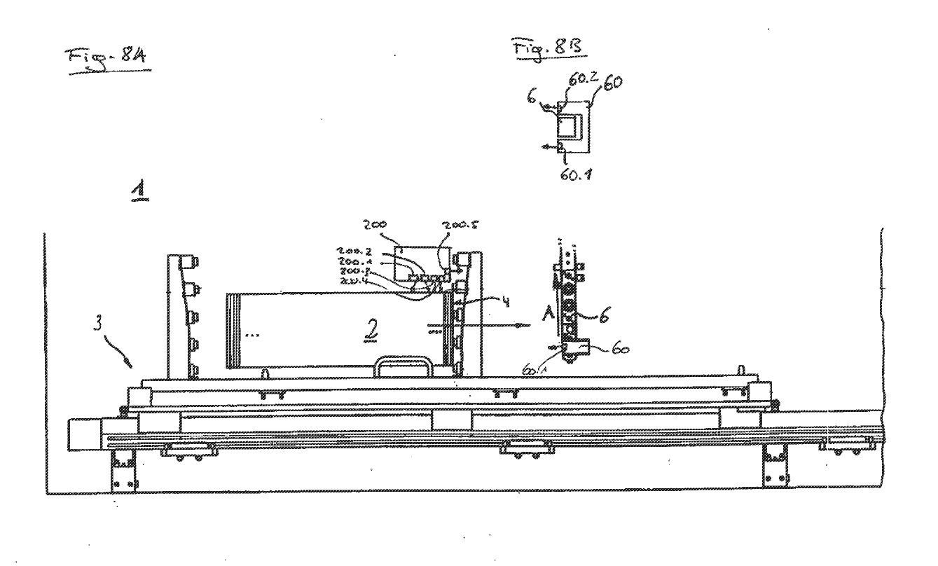

As shown in FIGS. 8A and 8B, in order to facilitate the separation of the plate-shaped elements from the stack 2, a separating-nozzle device 200 and a retaining-nozzle device 60 arranged in the device 1. The separating-nozzle device 200 is arranged above the stack 2. The retaining-nozzle device 60 is arranged, starting from the stack 2, directly behind the first belt-conveyor device 6.

The separating-nozzle device 200 provides several separating nozzles 200.1-200.4, which open above the stack 2 into the bath of liquid. By means of the separating nozzles 200.1-200.4, liquid jets are generated in the bath of liquid. In this context, the separating nozzles 200.1-200.4 are arranged in such a manner that the liquid jets lead to a spacing of the plate-shaped elements in the stack 2. For this purpose, the separating-nozzles 200.1-200.4 are orientated in such a manner that the liquid jets extend at least partially substantially parallel to the plate-shaped elements. However, at the same time, the separating jets 200.1-200.4 are also orientated, in such a manner that the liquid jets also provide components perpendicular to the plate-shaped elements and accordingly parallel to the conveying direction of the stack 2. Accordingly, liquid is introduced in a simple manner between the plate-shaped elements.

In order to simplify the conveying of a plate-shaped element from the stack 2 by means of the separator 5 or respectively the alternative separator 5′, an auxiliary nozzle 200.5 is formed in the separating-nozzle device 200. The auxiliary nozzle 200.5 also opens into the bath of liquid. A liquid jet generated in the liquid bath by the auxiliary nozzle 200.5 pumps liquid within the liquid bath perpendicular to the plate-shaped elements and accordingly parallel to the conveying direction of the stack 2. This liquid let already at least partially pushes plate-shaped elements removed by the first belt-conveyor device 6 towards the first belt-conveyor device 6.

The retaining-nozzle device 60 is formed in a U-shape, wherein the plane in which the U is disposed is orientated perpendicular to the plane of the drawing in FIG. 8A and parallel to the conveying direction of the stack 2. As shown in the plan view in FIG. 8B, the U surrounds the first belt-conveyor device 6. The retaining-nozzle device 60 comprises at least two retaining nozzles 60.1, 60.2—one at each end of the U—which open into the liquid bath and generate liquid jets within the liquid bath, which press against the stack 2 the plate-shaped elements which are directly adjacent to those plate-shaped elements which are disposed directly in contact with the first belt-conveyor device 6 and are directly removed by the latter from the stack 2. The liquid jets of the retaining nozzles 60.1, 60.2 provide components parallel to the conveying direction of the stack 2.

1. A device for separating plate-shaped elements from a stack (2) with a first belt-conveyor device (6) and a second belt-conveyor device (7), wherein the first belt-conveyor device (6) is provided in each case for receiving one plate-shaped element (12) from the stack (2), and the second belt-conveyor device (7) is provided for further transport and for depositing the plate-shaped elements (12) on a further transport device (8, 8′);
wherein the first and the second belt-conveyor device (6, 7) are connected to a device (VP) for generating a vacuum pressure, and a first belt (10) of the first belt-conveyor device (6) provides first openings (30), and a second belt (13, 15) of the second belt-conveyor device CO provides second openings,
characterised in that
the opening cross-sections of the second openings are smaller than the opening cross-sections of the first openings, and
that the second openings in the second belt are introduced as cuts (31).

2. The device according to claim 1,
characterised in that
the first openings (30) of the first belt are introduced into the belt as recesses.

3. The device according to any one of claims 1 to 2,
characterised in that
at least a portion (7.2) of the second belt-conveyor device (7) is rotatable, so that, in a starting position, a conveying plane in the region of this portion is orientated parallel to a conveying plane of the first belt-conveyor (6), and, in a second, rotated position, encloses an angle with the latter.

4. The device according to claim 3,
characterised in that
the second belt-conveyor device (7) provides a first portion (7.1) and a second portion (7.2), wherein the conveying plane of the first portion (7.1) is identical to the conveying plane of the first belt-conveyor device (6), and the second portion (7.2) is arranged in a rotatable manner.

5. The device according to any one of claim 3 or 4,
characterised in that
the rotatable portion (7.2) and the first belt-conveyor device (6) are arranged in such a manner that the plate-shaped elements (12) conveyed by the first belt-conveyor device contact its belt (10) with a first surface (25), and the plate-shaped elements (12) conveyed by the rotatable portion (7.2) of the second belt-conveyor device (7) contact the belt of the rotatable portion (7.2) with a second surface (26) facing away from the former.

6. The device according to any one of claim 3 or 4,
characterised in that
the rotatable portion (7.2) and the first belt-conveyor device (6) are arranged in such a manner that the plate-shaped elements (12) conveyed by the first belt-conveyor device (6) contact its belt (10) with a first surface (25), and the plate-shaped elements (12) conveyed by the rotatable portion (7.2′) of the second belt-conveyor device (7) contact the belt of the rotatable portion (7.2) with the same first surface (25).

7. The device according to any one of claims 3 to 6,
characterised in that
a transport plane (20) of the further transport device (8, 8′) is disposed parallel to the conveying plane of the rotatable portion (7.2) in the rotated position.

8. The device according to claim 5,
characterised in that
the rotatable portion (7.2) of the second belt-conveyor device (7) and the further transport device (8) are orientated relative to one another in such a manner that the belt (15) of the rotatable portion (7.2) and a conveyor means (18) of the further transport device (8) are disposed opposite to one another in the rotated position of the portion (7.2) of the second belt-conveyor device (7).

9. The device according to any one of claims 5 to 8,
characterised in that
a wetting device (22) is arranged in the region of the further transport device (8, 8′) and of the rotatable portion (7.2, 7.2).

10. The device according to claim 5,
characterised in that,
on a side of the belt (15) facing away from the transport side, the second belt-conveyor device (7) provides a displaceable device (27) for the deflection of the belt (15).

11. The device according to claim 10,
characterised in that
the displaceable device (27) provides, arranged in a retaining chamber (28), an elastic element which can be filled with a fluid in order to enlarge it.
